(19) United States
(12) Patent Application Publication
(10) Pub. No.: US 2024/0248494 A1
(43) Pub. Date: Jul. 25, 2024

(54) CONTROL DEVICE AND CONTROL METHOD FOR VEHICLE

(71) Applicant: HONDA MOTOR CO., LTD., Tokyo (JP)

(72) Inventors: Akihiro SEKINO, Tokyo (JP); Makoto NAKATSUKA, Tokyo (JP)

(21) Appl. No.: 18/409,572

(22) Filed: Jan. 10, 2024

(30) Foreign Application Priority Data
Jan. 25, 2023 (JP) 2023-009567

(51) Int. Cl. G05D 1/86; G05D 1/223; G05D 1/227; G05D 109/10; G05D 111/30

(52) U.S. Cl. CPC G05D 1/86; G05D 1/223; G05D 1/227; G05D 2109/10; G05D 2111/30

(57) ABSTRACT

A control device installed in a vehicle includes a traveling control unit capable of executing traveling control based on a traffic environment around the vehicle and a device control unit configured to cause a mobile device to execute a part of processing of the traveling control. The traveling control unit is capable of executing first traveling control in a case where the mobile device is available for the traveling control, and executing second traveling control having more tasks for a driver than the first traveling control without executing the first traveling control in a case where the mobile device is not available for the traveling control.

### CROSS-REFERENCE TO RELATED APPLICATION(S)

This application claims priority to and the benefit of Japanese Patent Application No. 2023-009567, filed Jan. 25, 2023, the entire disclosure of which is incorporated herein by reference.

### BACKGROUND OF THE INVENTION

### Field of the Invention

The present invention relates to a control device and a control method for a vehicle.

### Description of the Related Art

There has been known technology for automatically controlling traveling of a vehicle 1 based on a traffic environment of the vehicle (Japanese Patent Laid-Open No. 2022-171709). In addition, technology for offloading a part of processing by a computer to external modules has been proposed (Japanese Patent Laid-Open No. 2021-501528). By causing a mobile device to execute a part of processing of traveling control of the vehicle, the processing load of a control device of the vehicle is reduced.

### SUMMARY OF THE INVENTION

Some aspects of the present disclosure provide technology for effectively using a mobile device at the time of performing traveling control of a vehicle.

According to an embodiment, a control device installed in a vehicle, the control device comprising: a traveling control unit capable of executing traveling control based on a traffic environment around the vehicle; and a device control unit configured to cause a mobile device to execute a part of processing of the traveling control, wherein the traveling control unit is capable of executing first traveling control in a case where the mobile device is available for the traveling control, and executing second traveling control having more tasks for a driver than the first traveling control without executing the first traveling control in a case where the mobile device is not available for the traveling control is provided.

### BRIEF DESCRIPTION OF THE DRAWINGS

FIG. 1 is a block diagram illustrating a configuration example of a vehicle in some embodiments;

FIG. 2 is a block diagram illustrating a configuration example of a vehicle and a mobile device in some embodiments;

FIG. 3 is a flowchart illustrating an operation example of a control device in some embodiments; and

FIG. 4 is a flowchart illustrating an operation example of the control device in some embodiments.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

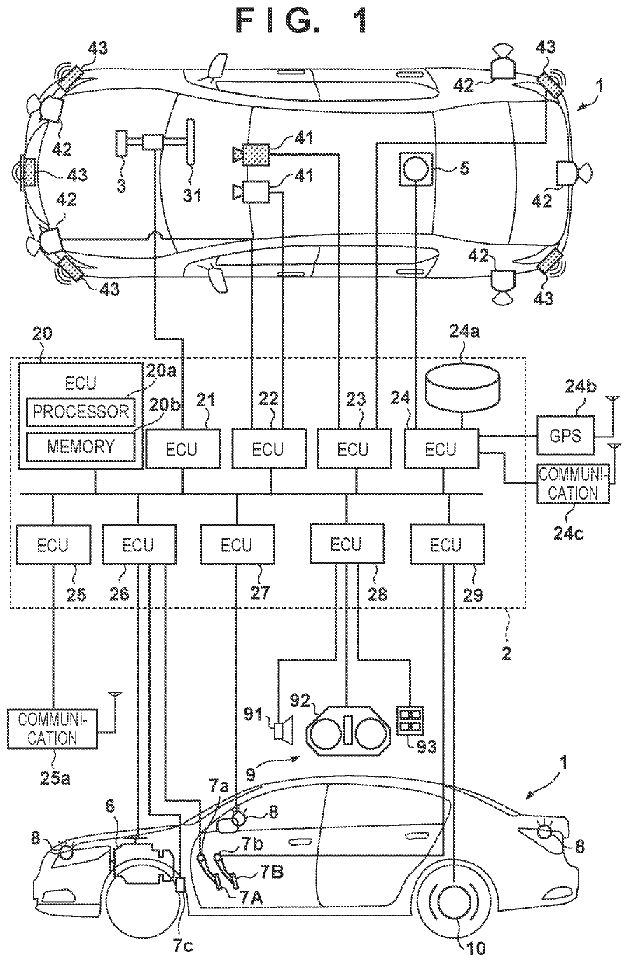

FIG. 1 is a block diagram of a vehicle 1 according to an embodiment of the present invention. In FIG. 1, the vehicle 1 is schematically illustrated in a plan view and in a side view. The vehicle 1 is, for example, a sedan-type four-wheeled passenger vehicle. The vehicle 1 may be such a four-wheeled vehicle, a two-wheeled vehicle, or another type of vehicle.

The vehicle 1 includes a vehicle control device 2 (hereinafter, simply referred to as a control device 2) that controls the vehicle 1. The control device 2 includes a plurality of electronic control units (ECUs) 20 to 29 connected to be able to communicate with each other through an in-vehicle network. Each of the ECUs includes a processor represented by a central processing unit (CPU), a memory such as a semiconductor memory, an interface with an external device, and the like. The memory stores a program to be executed by the processor, data to be used for processing by the processor, and the like. Each ECU may include a plurality of processors, memories, interfaces, and the like. For example, the ECU 20 includes a processor 20a and a memory 20b. The ECU 20 executes processing by the processor 20a executing a command included in the program stored in the memory 20b. Alternatively, the ECU 20 may include a dedicated integrated circuit such as an application specific integrated circuit (ASIC) or a field programmable gate array (FPGA) for causing the ECU 20 to execute processing. The same applies to other ECUs.

Hereinafter, functions and the like assigned to the ECUs 20 to 29 will be described. Note that the number of ECUs and functions assigned to the ECUs can be appropriately designed, and can be subdivided or integrated as compared with those in the present embodiment.

The ECU 20 executes control related to automated traveling of the vehicle 1. For example, the ECU 20 automatically controls at least one of steering of the vehicle 1 and acceleration and deceleration of the vehicle 1 based on a traffic environment (for example, a position of a white line, a position and a speed of a preceding vehicle, and the like) of the vehicle 1. The automated control of steering may include lane keeping control for keeping the vehicle 1 at a predetermined position (for example, a lane center) in a lane. The self-propelled control of acceleration/deceleration may include following traveling control for controlling the speed of the vehicle 1 so as to follow the preceding vehicle. The automated traveling control by the ECU 20 may include automated traveling control that does not require a driver to perform a traveling operation (which may also be referred to as automated driving) and automated traveling control for assisting the driver in performing the traveling operation (which may also be referred to as driving assistance).

The ECU 21 controls an electric power steering device 3. The electric power steering device 3 includes a mechanism that steers front wheels in accordance with a driver's driving operation (steering operation) on a steering wheel 31. In addition, the electric power steering device 3 includes a motor that exerts a driving force for assisting the steering operation or automatically steering the front wheels, a sensor that detects a steering angle, and the like. When a driving state of the vehicle 1 is automated driving, the ECU 21 automatically controls the electric power steering device 3 in response to an instruction from the ECU 20 and controls a traveling direction of the vehicle 1.

The ECUs 22 and 23 control detection units 41 to 43 that detect a surrounding situation of the vehicle 1, and perform information processing on detection results. The detection units 41 are cameras that capture images in front of the vehicle 1 (which may also hereinafter be referred to as cameras 41), and are attached to a windshield on an interior side of the vehicle at the front of a roof of the vehicle 1 in the present embodiment. By analyzing the images captured by the cameras 41, it is possible to extract a contour of a target object or a lane division line (white line or the like) on a road.

The detection units 42 are light detection and ranging (LiDARs) (which may also hereinafter be referred to as LiDARs 42), and detect a target object around the vehicle 1, or measure a distance to the target object. In the present embodiment, five LiDARs 42 are provided, including one at each corner of a front portion of the vehicle 1, one at a center of a rear portion of the vehicle 1, and one on each lateral side of the rear portion of the vehicle 1. The detection units 43 are millimeter-wave radars (which may also hereinafter be referred to as radars 43), and detect a target object around the vehicle 1 or measure a distance to the target object. In the present embodiment, five radars 43 are provided, including one at the center of the front portion of the vehicle 1, one at each corner of the front portion of the vehicle 1, and one at each corner of the rear portion of the vehicle 1.

The ECU 22 controls one camera 41 and each LiDAR 42, and performs information processing on detection results. The ECU 23 controls the other camera 41 and each radar 43, and performs information processing on detection results. By providing two sets of devices for detecting the surrounding situation of the vehicle 1, the reliability of the detection results can be improved, and by providing different types of detection units such as cameras, LiDARs, and radars, the surrounding environment of the vehicle 1 can be analyzed in multiple ways.

The ECU 24 controls a gyro sensor 5, a global navigation satellite system (GNSS) sensor 24b, and a communication device 24c, and performs information processing on detection results or communication results. The gyro sensor 5 detects a rotational movement of the vehicle 1. A course of the vehicle 1 can be determined based on a detection result of the gyro sensor 5, a wheel speed, and the like. The GNSS sensor 24b detects a current position of the vehicle 1. The communication device 24c performs wireless communication with a server that provides map information and traffic information to acquire such information therefrom. The ECU 24 can access a database 24a in which map information is stored, and the ECU 24 searches for a route from a current location to a destination. The ECU 24, the database 24a, and the GNSS sensor 24b constitute a so-called navigation device.

The ECU 25 includes a communication device 25a for inter-vehicle communication. The communication device 25a performs wireless communication with other surrounding vehicles to exchange information between the vehicles.

The ECU 26 controls a power plant 6. The power plant 6 is a mechanism that outputs a driving force for rotating driving wheels of the vehicle 1, and includes, for example, an engine and a transmission. For example, the ECU 26 controls an output of the engine according to a driver's driving operation (accelerator operation or acceleration operation) detected by an operation detection sensor 7a provided on an accelerator pedal 7A, or switches a gear ratio of the transmission based on information such as a vehicle speed detected by a vehicle speed sensor 7c. In a case where the driving state of the vehicle 1 is the automated driving, the ECU 26 automatically controls the power plant 6 in response to an instruction from the ECU 20, and controls the acceleration/deceleration of the vehicle 1.

The ECU 27 controls lighting devices (headlights, taillights, and the like) including direction indicators 8 (winkers). In the example of FIG. 1, the direction indicator 8 is provided in the front portion, the door mirror, and the rear portion of the vehicle 1.

The ECU 28 controls an input/output device 9. The input/output device 9 outputs information to the driver, and receives information input from the driver. A voice output device 91 notifies the driver of information by voice. A display device 92 notifies the driver of information by displaying an image. The display device 92 is disposed, for example, in front of the driver's seat, and constitutes an instrument panel or the like. Note that, although the voice and the display have been given as examples here, information may be notified by vibration or light. In addition, information may be notified by a combination of two or more of the voice, the display, the vibration, and the light. Furthermore, the combination or the mode of notification may be changed depending on the level (for example, a degree of urgency) of information to be notified. An input device 93 is a group of switches disposed at driver-operable positions to give an instruction to the vehicle 1, and may also include a voice input device.

The ECU 29 controls a brake device 10 and a parking brake (not illustrated). The brake device 10 is, for example, a disc brake device, and is provided on each wheel of the vehicle 1 to apply resistance against a rotation of the wheel to decelerate or stop the vehicle 1. The ECU 29 controls the operation of the brake device 10 in response to the driver's driving operation (brake operation) detected by an operation detection sensor 7b provided on a brake pedal 7B, for example. When the driving state of the vehicle 1 is the automated driving, the ECU 29 automatically controls the brake device 10 in response to an instruction from the ECU 20, and controls the deceleration and stop of the vehicle 1. The brake device 10 and the parking brake are also capable of operating to maintain a stopped state of the vehicle 1. In a case where the transmission of the power plant 6 includes a parking lock mechanism, the parking lock mechanism can also be operated to keep the vehicle 1 in the stopped state.

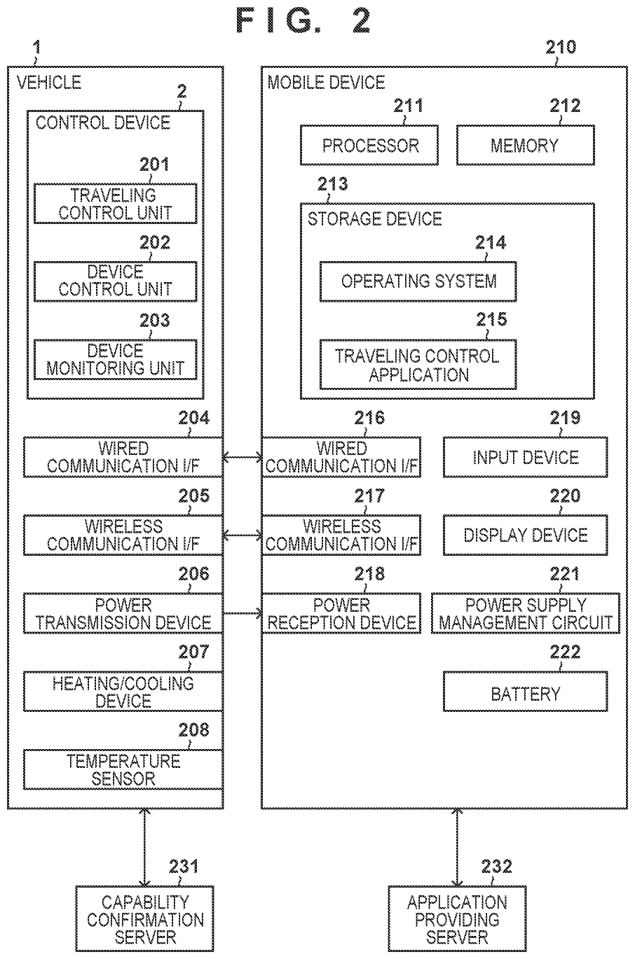

Detailed configurations of the vehicle 1 and the mobile device 210 according to some embodiments will be described with reference to FIG. 2. In some embodiments, the control device 2 of the vehicle 1 executes traveling control using the mobile device 210. For example, the control device 2 may cause the mobile device 210 to execute a part of processing of the traveling control of the vehicle 1. The mobile device 210 is a device separate from the vehicle 1, and can be used independently of the vehicle 1. The mobile device 210 may be, for example, a smartphone, a tablet, a laptop computer, or the like.

In some embodiments, the vehicle 1 may include a wired communication interface (I/F) 204, a wireless communication I/F 205, a power transmission device 206, a heating/cooling device 207, and a temperature sensor 208 in addition to the components described in FIG. 1. The wired communication I/F 204 is an I/F for wired communication with another device (for example, the mobile device 210). For example, the wired communication I/F 204 may include a connector and a signal processing circuit. The wired communication I/F 204 may conform to an arbitrary communication standard (for example, Universal Serial Bus (USB) (registered trademark)).

The wireless communication I/F 205 is an I/F for wireless communication with another device (for example, the mobile device 210). For example, the wireless communication I/F 205 may include an antenna and a signal processing circuit. The wireless communication I/F 205 may conform to an arbitrary communication standard (for example, WiFi (registered trademark) or Bluetooth (registered trademark)). The wireless communication between the vehicle 1 and the mobile device 210 may be communication not involving another communication device (so-called direct communication), or may be communication involving another communication device such as a base station. The wireless communication I/F 205 may be communicable with a mobile network in compliance with a 3GPP (registered trademark) (3rd Generation Partnership Project) standard, for example.

The power transmission device 206 is hardware for supplying power to another device (for example, the mobile device 210). The power transmission device 206 may supply power by wire or may supply power wirelessly. When power is supplied by wire, the power transmission device 206 may have a connector. One connector may serve as both the connector of the power transmission device 206 and the connector of the wired communication I/F 204. The power transmission device 206 may supply power to the mobile device 210 while the mobile device 210 is used for traveling control.

The heating/cooling device 207 is hardware for heating or cooling the mobile device 210 from the outside. For example, the heating/cooling device 207 may include a heater for heating the mobile device 210 or may include a fan for cooling the mobile device 210. The mobile device 210 may be installed at a predetermined position of the vehicle 1 when traveling control processing is executed. For example, the vehicle 1 may have a holder for holding the mobile device 210 or may have a stand for placing the mobile device 210. The heating/cooling device 207 may be disposed at a position where the mobile device 210 installed at the predetermined position as described above can be heated or cooled.

The temperature sensor 208 is a sensor for measuring the temperature of the mobile device 210 from the outside. For example, the temperature sensor 208 may be disposed at a position where the temperature of the mobile device 210 installed at the predetermined position can be measured.

The control device 2 of the vehicle 1 may include a traveling control unit 201, a device control unit 202, and a device monitoring unit 203. These functions may be realized, for example, by the processor 20a of the ECU 20 executing a program stored in the memory 20b of the ECU 20. Alternatively, these functions may be realized by a dedicated circuit.

The traveling control unit 201 controls traveling of the vehicle 1. For example, the traveling control unit 201 executes traveling control of the vehicle 1 based on a traffic environment around the vehicle 1. The traveling control of the vehicle 1 may include control of steering of the vehicle 1. For example, the traveling control unit 201 may control the steering of the vehicle 1 so that the vehicle 1 maintains the center of a lane. In addition to or instead of the steering control, the traveling control of the vehicle 1 may include control of acceleration and deceleration of the vehicle 1. For example, the traveling control unit 201 may control acceleration and deceleration of the vehicle 1 so that the vehicle 1 follows the preceding vehicle. When the traveling control unit 201 controls both steering and acceleration/deceleration of the vehicle 1, the traveling control unit 201 may be capable of executing a lane change of the vehicle 1.

The traveling control unit 201 may recognize the traffic environment around the vehicle 1 based on at least one of output results from the detection units 41 to 43, information acquired from a device outside the vehicle 1 (for example, another vehicle or a roadside device), and map information. The traveling control unit 201 may recognize the target object around the vehicle 1 based on the output results from the detection units 41 to 43. The traveling control unit 201 may calculate a trajectory that the vehicle 1 should take based on the traffic environment around the vehicle 1, and may control steering and acceleration/deceleration of the vehicle 1 so as to achieve this trajectory.

The device control unit 202 controls the operation of the mobile device 210 connected to the vehicle 1. For example, the device control unit 202 may cause the mobile device 210 to execute a part of the processing of the traveling control of the vehicle 1. Specifically, in response to an instruction from the traveling control unit 201, the device control unit 202 instructs the mobile device 210 to execute processing by transmitting content of the processing of the traveling control and data used for the processing to the mobile device 210. For example, the device control unit 202 may transmit the output results from the detection units 41 to 43 to the mobile device 210, and may instruct recognition of the target object around the vehicle 1. Alternatively or additionally, the device control unit 202 may instruct calculation of the trajectory that the vehicle 1 should take.

The device control unit 202 receives a response to the instruction from the mobile device 210, and transfers a processing result included in the response to the traveling control unit 201. The traveling control unit 201 controls the traveling of the vehicle 1 by integrating the processing result acquired from the mobile device 210 and the result of the processing executed by the traveling control unit 201.

The device control unit 202 may confirm whether or not the mobile device 210 has the capability to execute the processing of the traveling control. For example, in a case where the capability (processing speed or the like) of the mobile device 210 is higher than a threshold, the device control unit 202 may determine that the mobile device 210 has the capability to execute the processing of the traveling control. Alternatively or additionally, the device control unit 202 may inquire of a capability confirmation server 231 whether or not the mobile device 210 has the capability to execute the processing of the traveling control.

The device monitoring unit 203 monitors a state of the mobile device 210. For example, the device monitoring unit 203 may monitor a processing speed, a temperature, a remaining charge amount, a communication situation, and the like of the mobile device 210. The device monitoring unit 203 may monitor the state of the mobile device 210 based on the information received from the mobile device 210. For example, the device monitoring unit 203 may receive a processing speed, a temperature, a remaining charge amount, and the like measured in the mobile device 210 from the mobile device 210. Alternatively or additionally, the device monitoring unit 203 may monitor the state of the mobile device 210 based on the output result of the temperature sensor 208. Alternatively or additionally, the device monitoring unit 203 may monitor the state of the mobile device 210 based on the communication situations of the wired communication I/F 204 and the wireless communication I/F 205.

The mobile device 210 may have the components illustrated in FIG. 2. The processor 211 is a processing circuit that executes the overall operation of the mobile device 210. The memory 212 is a storage circuit that temporarily stores programs and data for processing by the processor 211. For example, the memory 212 may include a random access memory (RAM). The storage device 213 is a storage device that stores programs and data used by the mobile device 210. For example, the storage device 213 may include a flash memory, a solid state disk (SSD), or the like.

An operating system 214 and a traveling control application 215 may be stored in the storage device 213. The operating system 214 and the traveling control application 215 are read into the memory 212 and executed by the processor 211. The operating system 214 is software that provides basic functions of the mobile device 210. The traveling control application 215 is software that executes the processing of the traveling control in accordance with an instruction from the control device 2 of the vehicle 1. The mobile device 210 may be able to download the traveling control application 215 from an application providing server 232. The mobile device 210 may be able to acquire updated data of the traveling control application 215 from the application providing server 232. As such, the mobile device 210 can acquire data for updating the function for executing the processing of the traveling control from a device different from the vehicle 1, that is, the application providing server 232.

The wired communication I/F 216 is an I/F for wired communication with another device (for example, the vehicle 1). For example, the wired communication I/F 216 may include a connector and a signal processing circuit. The wired communication I/F 216 may conform to an arbitrary communication standard (for example, USB).

The wireless communication I/F 217 is an I/F for wireless communication with another device (for example, the vehicle 1). For example, the wireless communication I/F 217 may include an antenna and a signal processing circuit. The wireless communication I/F 217 may conform to an arbitrary communication standard (for example, WiFi or Bluetooth). The wireless communication I/F 217 may be communicable with a mobile network in compliance with a 3GPP standard, for example.

A power reception device 218 is hardware for receiving power from another device (for example, the vehicle 1 or a charger). The power reception device 218 may receive power by wire or may receive power wirelessly. When power is received by wire, the power reception device 218 may have a connector. One connector may serve as both the connector of the power reception device 218 and the connector of the wired communication I/F 216.

An input device 219 is a device for receiving an input from a user of the mobile device 210. For example, the input device 219 may include a touch panel, a keyboard, a button, a joystick, or the like. A display device 220 is a device for presenting information to the user of the mobile device 210. The display device 220 may include a liquid crystal display, an organic electroluminescence (EL) display, a light, and the like.

A power supply management circuit 221 is a circuit that manages power supply to each component of the mobile device 210. For example, the power supply management circuit 221 may charge a battery 222 using power received from another device through the power reception device 218. The power supply management circuit 221 may supply power stored in the battery 222 to each component of the mobile device 210. Further, the power supply management circuit 221 may distribute power received from another device through the power reception device 218 to the charging of the battery 222 and the supply to each component of the mobile device 210.

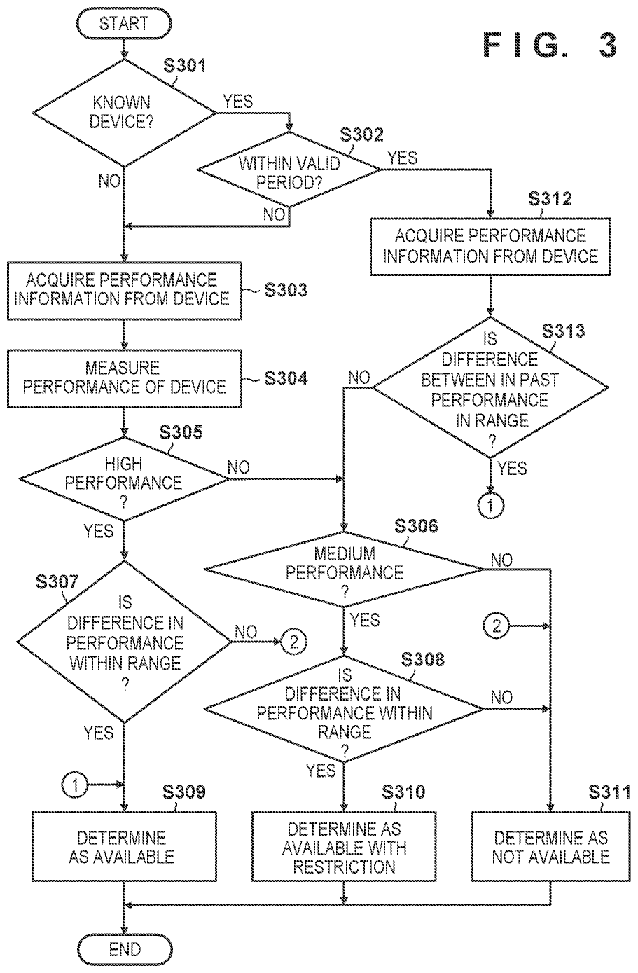

An operation for the control device 2 of the vehicle 1 to determine whether or not the mobile device 210 can be used for the traveling control will be described with reference to FIG. 3. Each step of a method of FIG. 3 may be performed by a processor (for example, the processor 20a of the ECU 20) of the control device 2 executing a program read into a memory (for example, the memory 20b of the ECU 20) of the control device 2. Alternatively, some or all steps of the method of FIG. 3 may be performed by a dedicated circuit. The operation of FIG. 3 may be initiated, for example, in response to the mobile device 210 being connected to the vehicle 1 both in wired connection and in wireless connection.

In S301, the device control unit 202 determines whether or not the mobile device 210 connected to the vehicle 1 has been used for the traveling control in the past. When it is determined that the mobile device 210 has been used for the traveling control in the past (“YES” in S301), the control device 2 shifts the processing to S302, and otherwise (“NO” in S301), the control device 2 shifts the processing to S303. For example, the device control unit 202 may store identification information of the mobile device used for the traveling control in the past in the memory. The device control unit 202 acquires identification information from the mobile device 210 newly connected to the vehicle 1. When the acquired identification information is stored in the memory, the device control unit 202 may determine that the mobile device 210 has been used for the traveling control in the past. When the acquired identification information is not stored in the memory, the device control unit 202 may determine that the mobile device 210 has not been used for the traveling control in the past. The identification information of the mobile device 210 is information for the control device 2 to uniquely identify the mobile device 210, and may be, for example, a serial number of the mobile device 210.

In S302, the device control unit 202 determines whether or not a current time is within a period of time for reusing the mobile device 210. When it is determined that the current time is within the period of time for reusing (“YES” in S302), the control device 2 shifts the processing to S312, and otherwise (“NO” in S302), the control device 2 shifts the processing to S303. For example, the device control unit 202 may determine that the current time is within the period of time for reusing the mobile device 210, when the current time is within a threshold number of days (for example, 30 days) from the previous use of the mobile device 210.

In S303, the device control unit 202 acquires performance information measured by the mobile device 210 from the mobile device 210. For example, the mobile device 210 may measure an execution time of a test program, and may provide the time to the control device 2 as performance. The test program may be included in the traveling control application 215 or may be acquired from the control device 2 in S303.

In S304, the device control unit 202 measures the performance of the mobile device 210. For example, the device control unit 202 may instruct the mobile device 210 to execute the test program, and may use a time until a response is returned to the instruction as the performance of the mobile device 210.

In S305, the device control unit 202 determines whether or not the mobile device 210 has high performance. When it is determined that the mobile device 210 has the high performance (“YES” in S305), the control device 2 shifts the processing to S307, and otherwise (“NO” in S305), the control device 2 shifts the processing to S306. In S306, the device control unit 202 determines whether or not the mobile device 210 has medium performance. When it is determined that the mobile device 210 has the medium performance (“YES” in S306), the control device 2 shifts the processing to S308, and otherwise (“NO” in S306), the control device 2 shifts the processing to S311. As described above, in S305 and S306, the device control unit 202 classifies the performance of the mobile device 210 into three stages of high performance, medium performance, and low performance. This classification may be performed based on the performance obtained in S303, or may be performed based on the performance measured in S304. For example, the mobile device 210 may be determined to have the high performance when the execution time of the test program is shorter than a first threshold time, may be determined to have the medium performance when the execution time is longer than the first threshold time and shorter than a second threshold time (this is longer than the first threshold time), and may be determined to have the low performance when the execution time is longer than the second threshold time. The mobile device 210 determined to have the medium performance executes the processing of the traveling control with some functions restricted as compared with a mobile device determined to have the high performance. When the mobile device 210 is determined to have the low performance, in S311, the device control unit 202 determines that the mobile device 210 is not available for the traveling control.

When the mobile device 210 is determined to have the high performance, in S307, the device control unit 202 determines whether or not a difference between the performance acquired in S303 and the performance acquired in S304 is within a threshold range. When it is determined that the performance difference is within the threshold range (“YES” in S307), the control device 2 shifts the processing to S309, and otherwise (“NO” in S307), the control device 2 shifts the processing to S311. The device control unit 202 may compare the two performances directly or may request the capability confirmation server 231 to perform the comparison. When the difference between the two performances is outside the threshold range, the mobile device 210 may not be able to execute the test program normally or measure the performance correctly. Therefore, in S311, the device control unit 202 determines that the mobile device 210 is not available for the traveling control. On the other hand, when the difference between the two performances is within the threshold range, in S309, the device control unit 202 determines that the mobile device 210 is available for the traveling control.

When the mobile device 210 is determined to have the medium performance, in S308, the device control unit 202 determines whether or not a difference between the performance acquired in S303 and the performance acquired in S304 is within a threshold range. When it is determined that the performance difference is within the threshold range (“YES” in S308), the control device 2 shifts the processing to S310, and otherwise (“NO” in S308), the control device 2 shifts the processing to S311. The device control unit 202 may compare the two performances directly or may request the capability confirmation server 231 to perform the comparison. When the difference between the two performances is outside the threshold range, the mobile device 210 may not be able to execute the test program normally or measure the performance correctly. Therefore, in S311, the device control unit 202 determines that the mobile device 210 is not available for the traveling control. On the other hand, when the difference between the two performances is within the threshold range, in S310, the device control unit 202 determines that the mobile device 210 is available for the traveling control with a restriction.

In S312, the device control unit 202 acquires performance information measured by the mobile device 210 from the mobile device 210, similarly to S303. In S313, the device control unit 202 determines whether or not a difference between the performance acquired in S312 and the performance acquired when the mobile device 210 is used before is within a threshold range. When it is determined that the performance difference is within the threshold range (“YES” in S313), the control device 2 shifts the processing to S309, and otherwise (“NO” in S312), the control device 2 shifts the processing to S306.

According to the method of FIG. 3, when the mobile device 210 has the high performance and the performance measurement result is reliable, it is determined that the mobile device 210 is available for the traveling control. In this case, the traveling control unit 201 may cause the mobile device 210 to execute a part of the processing of the traveling control. When the mobile device 210 is available for the traveling control, the processing capability of the traveling control is improved as compared with when the mobile device 210 is not available for the traveling control. Therefore, when the mobile device 210 is available for the traveling control, the traveling control unit 201 may be capable of executing traveling control with a smaller restriction as compared with when the mobile device 210 is not available for the traveling control. In the following description, the traveling control that can be executed by the traveling control unit 201 when the mobile device 210 is not available for the traveling control is referred to as normal traveling control. The traveling control that can be executed by the traveling control unit 201 when the mobile device 210 is available for the traveling control is referred to as extended traveling control. The extended traveling control has a smaller restriction than the normal traveling control. In other words, the normal traveling control has a larger restriction than the extended traveling control. For example, the large restriction may include that there are many tasks for the driver. The tasks for the driver may include, for example, holding of the steering wheel 31, peripheral monitoring, and the like. For example, in the normal traveling control, the driver may be required to hold the steering wheel 31 and monitor the surroundings. In the extended traveling control, the driver is not required to hold the steering wheel 31, and may be required to monitor the surroundings.

The restriction related to the traveling control may include a restriction related to a traveling scene. That is, the number of traveling scenes in which the extended traveling control can be executed may be larger than the number of traveling scenes in which the normal traveling control can be executed. For example, the normal traveling control may be executable only on highways, and the extended traveling control may be executable on both highways and ordinary roads. For example, the normal traveling control may be executable when the vehicle 1 is at or below a specific speed (for example, 30 km/h), and the extended traveling control may be executable when the vehicle 1 is at or below a higher speed (for example, 60 km/h).

The restriction related to the traveling control may include a restriction related to a task imposed on the driver. That is, the task imposed on the driver in the extended traveling control may be less than the task imposed on the driver in the normal traveling control. For example, the driver may be required to hold the steering in the normal traveling control, and the driver may not be required to hold the steering in the extended traveling control. Alternatively, the driver may be required to monitor the surroundings of the vehicle 1 in the normal traveling control, and the driver may not be required to monitor the surroundings of the vehicle 1 in the extended traveling control.

The restriction related to the traveling control may include a restriction related to a traveling function. That is, the number of traveling functions that can be executed in the extended traveling control may be larger than the number of traveling functions that can be executed in the normal traveling control. For example, a specific function (for example, the lane change) may not be executable in the normal traveling control, and the specific function (for example, the lane change) may be executable in the extended traveling control.

The device control unit 202 may cause the mobile device 210 to execute processing that is executed in the extended traveling control and is not executed in the normal traveling control. The mobile device 210 determined to have the high performance can have higher performance than an ECU (for example, the ECU 20) of the control device 2. Therefore, processing having a high processing capability (for example, calculation of a trajectory for performing the lane change) may be executed by the mobile device 210.

According to the method of FIG. 3, when the mobile device 210 has the medium performance and the measurement result of the performance is reliable, it is determined that the mobile device 210 is available for the traveling control with a restriction. In this case, the traveling control unit 201 may cause the mobile device 210 to execute a part of the processing of the traveling control. The traveling control unit 201 may be capable of executing traveling control having a larger restriction than the extended traveling control and having a smaller restriction than the normal traveling control.

According to the method of FIG. 3, when the mobile device 210 has the low performance or the measurement result of the performance is unreliable, it is determined that the mobile device 210 is not available for the traveling control. In this case, the traveling control unit 201 may not cause the mobile device 210 to execute a part of the processing of the traveling control. The traveling control unit 201 may be capable of executing the normal traveling control without executing the extended traveling control.

In the method of FIG. 3, S302 may be omitted, and in this case, if “YES” in S301, the processing may transition to S312. In the method of FIGS. 3, S301, S302, S312, and S313 may be omitted, and in this case, the method of FIG. 3 starts from S303. In the method of FIG. 3, S307 may be omitted, and in this case, if “YES” in S305, the processing transitions to S309. Similarly, in the method of FIG. 3, S308 may be omitted. In the method of FIG. 3, one of S303 and S304 may be omitted, and in this case, S307 and S308 are also omitted. In the method of FIG. 3, the performance of the mobile device 210 may be classified into two stages of high performance and low performance. In this case, S306, S308, and S310 may be omitted, and the processing transitioning to S306 may transition to S311.

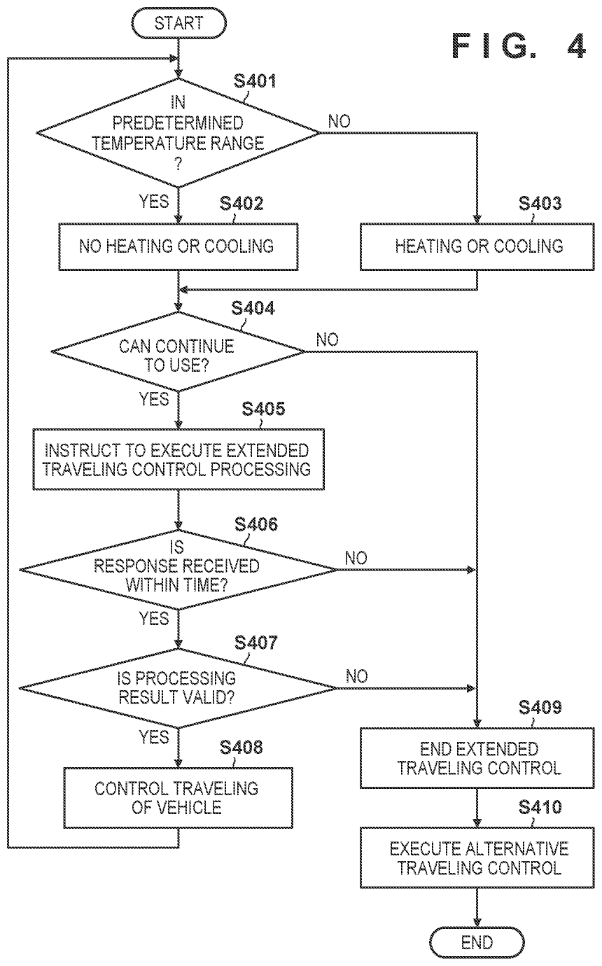

The operation of the control device 2 of the vehicle 1 using the mobile device 210 for the extended traveling control will be described with reference to FIG. 4. Each step of a method of FIG. 4 may be performed by a processor (for example, the processor 20a of the ECU 20) of the control device 2 executing a program read into a memory (for example, the memory 20b of the ECU 20) of the control device 2. Alternatively, some or all steps of the method of FIG. 4 may be performed by a dedicated circuit. The operation of FIG. 4 may be initiated in response to an instruction by the driver to start execution of the extended traveling control, for example, after the mobile device 210 is determined to be available or restrictively available for the traveling control in the method of FIG. 3.

In S401, the device monitoring unit 203 determines whether or not the temperature of the mobile device 210 is within a predetermined range. When it is determined that the temperature of the mobile device 210 is within the predetermined range (“YES” in S401), the control device 2 shifts the processing to S402, and otherwise (“NO” in S401), the control device 2 shifts the processing to S403. The temperature of the mobile device 210 used in this determination may be a temperature measured by the mobile device 210, a temperature measured by the temperature sensor 208, or both the temperatures. For example, the device monitoring unit 203 may determine YES in S401 when both the temperatures are within the predetermined range, or may determine YES in S401 when at least one of both the temperatures is within the predetermined range.

In S402, the device monitoring unit 203 does not perform heating or cooling using the heating/cooling device 207. If the operation of the heating/cooling device 207 is being performed, the device monitoring unit 203 stops the operation. If the heating/cooling device 207 is stopped, the device monitoring unit 203 maintains this state.

In S403, the device monitoring unit 203 heats or cools the mobile device 210 using the heating/cooling device 207. When the temperature of the mobile device 210 is higher than the predetermined range, the device monitoring unit 203 cools the mobile device 210 using the heating/cooling device 207. When the temperature of the mobile device 210 is lower than the predetermined range, the device monitoring unit 203 heats the mobile device 210 using the heating/cooling device 207.

In S404, the device control unit 202 determines whether or not the mobile device 210 is available for the traveling control. When it is determined that the mobile device 210 is available for the traveling control (“YES” in S404), the control device 2 shifts the processing to S405, and otherwise (“NO” in S404), the control device 2 shifts the processing to S409.

For example, the device control unit 202 may determine that the mobile device 210 is not available for the traveling control, when communication with the mobile device 210 is not possible in communication methods of both wired communication and wireless communication. As such, by setting communication in the two different communication methods to a condition, the reliability of communication between the control device 2 and the mobile device 210 at the time of the traveling control is improved.

The device control unit 202 may determine that the mobile device 210 is not available for the traveling control, when the temperature of the mobile device 210 is outside the predetermined range. This range may be wider than the range used for the determination of S401. For example, even if the mobile device 210 is cooled in S402, the temperature of the mobile device 210 may become too high when the processing load of the mobile device 210 is high. In such a case, the device control unit 202 determines that the mobile device 210 cannot be sufficiently cooled by the heating/cooling device 207, and determines that the mobile device 210 is not available for the traveling control. The temperature used in this determination may be a temperature measured by the mobile device 210, a temperature measured by the temperature sensor 208, or both the temperatures.

The device control unit 202 may determine that the mobile device 210 is not available for the traveling control, when the processing load (for example, a processor usage rate or a memory usage rate) of the mobile device 210 is outside a predetermined range. The device control unit 202 may obtain the processing load measured by the mobile device 210 from the mobile device 210.

When it is determined in S404 that the mobile device 210 is available for the traveling control, in S405, the device control unit 202 instructs the mobile device 210 to execute the processing of the extended traveling control. The instruction may include content of the processing and data used for the processing. The instruction may be transmitted in both the wired connection and the wireless connection, or may be transmitted in one of the wired connection and the wireless connection.

In S406, the device control unit 202 determines whether or not a response has been received from the mobile device 210 within a threshold time. When it is determined that the response has been received within the threshold time (“YES” in S406), the control device 2 shifts the processing to S407, and otherwise (“NO” in S406), the control device 2 shifts the processing to S409. When the response is not received within the threshold time, the device control unit 202 determines that the mobile device 210 is not available for the traveling control.

In S407, the device control unit 202 determines whether or not a result of the processing of the extended traveling control received from the mobile device 210 is valid. When it is determined that the result of the processing is valid (“YES” in S407), the control device 2 shifts the processing to S408, and otherwise (“NO” in S407), the control device 2 shifts the processing to S409. When the result of the processing is invalid, the device control unit 202 determines that the mobile device 210 is not available for the traveling control. For example, the device control unit 202 may determine whether or not the vehicle 1 can safely travel according to the result of the processing of the extended traveling control. For example, when the vehicle 1 travels according to the result of the process of the extended traveling control, the device control unit 202 may determine that the result of the processing is invalid in a case where the vehicle 1 deviates outside the road or the speed of the vehicle 1 exceeds the speed limit. As such, by confirming the validity of the result of the processing of the extended traveling control received from the mobile device 210, the safety of the traveling control is improved.

In S408, the traveling control unit 201 controls the traveling of the vehicle 1 using the result of the processing of the extended traveling control received from the mobile device 210. In parallel with the processing by the mobile device 210, the traveling control unit 201 may also execute a part of the processing of the extended traveling control directly and integrate the results of both the processing. Thereafter, the control device 2 repeats the processing from S401.

When it is determined in S404 that the mobile device 210 is not available for the traveling control, in S409, the device control unit 202 ends the extended traveling control. According to the end of the extended traveling control, the device control unit 202 may stop the operations of the heating/cooling device 207 and the power transmission device 206. After the end of the extended traveling control, the device control unit 202 does not cause the mobile device 210 to execute the processing of the traveling control.

In S410, the traveling control unit 201 executes alternative traveling control for stopping the vehicle 1. The device control unit 202 does not cause the mobile device 210 to execute processing of the alternative traveling control. S410 is executed when it is determined that the mobile device 210 is not available for the traveling control. Therefore, by executing the processing of the alternative traveling control by the traveling control unit 201 without causing the mobile device 210 to execute the processing of the alternative traveling control, the vehicle 1 can be safely stopped.

In the method of FIGS. 4, S401 to S403 may be omitted. In the method of FIG. 4, S407 may be omitted. In the method of FIG. 4, after ending the extended traveling control in S409, the traveling control unit 201 may transition to the normal traveling control, or may end the traveling control and transition to manual driving.

According to the above-described embodiment, when the mobile device 210 is available for the traveling control, the extended traveling control with a small restriction is executed, and when the mobile device 210 is not available for the traveling control, the normal traveling control with a large restriction is executed. As a result, the mobile device can be effectively used when the traveling control of the vehicle is executed.

### Summary of Embodiments

### [Item 1]

A control device (2) installed in a vehicle (1), the control device comprising:
a traveling control unit capable of executing traveling control based on a traffic environment around the vehicle; and
a device control unit configured to cause a mobile device (210) to execute a part of processing of the traveling control, wherein
the traveling control unit is capable of
   executing first traveling control in a case where the mobile device is available for the traveling control, and
   executing second traveling control having more tasks for a driver than the first traveling control without executing the first traveling control in a case where the mobile device is not available for the traveling control.

According to this item, the mobile device can be effectively used when the traveling control of the vehicle is executed.

### [Item 2]

The control device according to Item 1, wherein the device control unit causes the mobile device to execute processing executed in the first traveling control and not executed in the second traveling control.

According to this item, advanced processing can be executed using a mobile device having a high arithmetic processing capability.

### [Item 3]

The control device according to Item 1 or 2, further comprising a confirmation unit configured to confirm performance of the mobile device.

According to this item, a mobile device suitable for the processing of the traveling control can be identified.

### [Item 4]

The control device according to Item 3, wherein the traveling control unit determines that the mobile device is available for the traveling control in a case where the mobile device has predetermined performance.

According to this item, a mobile device suitable for the processing of the traveling control can be used.

### [Item 5]

The control device according to any one of Items 1-4, further comprising:
a communication unit capable of communicating with the mobile device by using a first communication method (216) and a second communication method (217) different from the first communication method, wherein
the traveling control unit determines that the mobile device is not available for the traveling control in a case where communication with the mobile device is not possible in both the first communication method and the second communication method.

According to this item, reliability of communication between the vehicle and the communication device is improved.

### [Item 6]

The control device according to any one of Items 1-5, wherein
the device control unit monitors a result of processing of the traveling control by the mobile device, and
the traveling control unit determines that the mobile device is not available for the traveling control in a case where the result of the processing of the traveling control by the mobile device is invalid.

According to this item, safety of the traveling control of the vehicle is improved.

### [Item 7]

The control device according to any one of Items 1-6, wherein the device control unit does not cause the mobile device to execute processing of alternative traveling control for stopping the vehicle.

According to this item, the vehicle can be safely stopped.

### [Item 8]

The control device according to any one of Items 1-7, wherein the mobile device acquires, from a device (232) different from the vehicle, data for updating a function for executing processing of the traveling control.

According to this item, the traveling control can be executed with the latest function.

### [Item 9]

A program that causes a computer to function as each unit of the control apparatus (2) according to any one of Items 1-8.

According to this item, a computer having the above advantages can be realized.

### [Item 10]

A method of controlling a vehicle (1), the vehicle being capable of executing traveling control based on a traffic environment around the vehicle, and causing a mobile device (210) to execute a part of processing of the traveling control, the method comprising:
executing first traveling control in a case where the mobile device is available for the traveling control; and
executing second traveling control having more tasks for a driver than the first traveling control without executing the first traveling control in a case where the mobile device is not available for the traveling control.

According to this item, the mobile device can be effectively used when the traveling control of the vehicle is executed.

The invention is not limited to the foregoing embodiments, and various variations/changes are possible within the spirit of the invention.

What is claimed is:

1. A control device installed in a vehicle, the control device comprising:
a traveling control unit capable of executing traveling control based on a traffic environment around the vehicle; and
a device control unit configured to cause a mobile device to execute a part of processing of the traveling control, wherein
the traveling control unit is capable of
executing first traveling control in a case where the mobile device is available for the traveling control, and
executing second traveling control having more tasks for a driver than the first traveling control without executing the first traveling control in a case where the mobile device is not available for the traveling control.

2. The control device according to claim 1, wherein the device control unit causes the mobile device to execute processing executed in the first traveling control and not executed in the second traveling control.

3. The control device according to claim 1, further comprising a confirmation unit configured to confirm performance of the mobile device.

4. The control device according to claim 3, wherein the traveling control unit determines that the mobile device is available for the traveling control in a case where the mobile device has predetermined performance.

5. The control device according to claim 1, further comprising:
a communication unit capable of communicating with the mobile device by using a first communication method and a second communication method different from the first communication method, wherein
the traveling control unit determines that the mobile device is not available for the traveling control in a case where communication with the mobile device is not possible in both the first communication method and the second communication method.

6. The control device according to claim 1, wherein
the device control unit monitors a result of processing of the traveling control by the mobile device, and
the traveling control unit determines that the mobile device is not available for the traveling control in a case where the result of the processing of the traveling control by the mobile device is invalid.

7. The control device according to claim 1, wherein the device control unit does not cause the mobile device to execute processing of alternative traveling control for stopping the vehicle.

8. The control device according to claim 1, wherein the mobile device acquires, from a device different from the vehicle, data for updating a function for executing processing of the traveling control.

9. A method of controlling a vehicle, the vehicle being capable of executing traveling control based on a traffic environment around the vehicle, and causing a mobile device to execute a part of processing of the traveling control, the method comprising:
executing first traveling control in a case where the mobile device is available for the traveling control; and
executing second traveling control having more tasks for a driver than the first traveling control without executing the first traveling control in a case where the mobile device is not available for the traveling control.

10. A non-transitory storage medium storing a program for causing a computer to execute a method of controlling a vehicle, wherein
the vehicle is capable of executing traveling control based on a traffic environment around the vehicle, and causes a mobile device to execute a part of processing of the traveling control, and
the method includes
executing first traveling control in a case where the mobile device is available for the traveling control, and
executing second traveling control having more tasks for a driver than the first traveling control without executing the first traveling control in a case where the mobile device is not available for the traveling control.
